(19) United States
(12) Patent Application Publication
(10) Pub. No.: US 2011/0151191 A1
(43) Pub. Date: Jun. 23, 2011

(54) CAMOUFLAGE SYSTEMS, KITS AND RELATED METHODS WITH FRICTIONAL CONTACT SURFACES

(76) Inventors: K. Dominic Cincotti, Wilmington, NC (US); Trevor J. Kracher, Lumberton, NC (US)

(21) Appl. No.: 12/950,634

(22) Filed: Nov. 19, 2010

Related U.S. Application Data
(63) Continuation-in-part of application No. 12/386,986, filed on Apr. 24, 2009.
(60) Provisional application No. 61/262,588, filed on Nov. 19, 2009.
(60) Provisional application No. 61/343,978, filed on May 6, 2010.

(51) Int. Cl. B32B 3/10; F41H 3/02; B32B 27/30; B65D 77/00; B32B 38/14; B32B 37/12; B82Y 99/00

(52) U.S. Cl. 428/143; 428/141; 428/152; 206/216; 156/277; 977/902

(57) ABSTRACT

Systems, kits and methods that are related to camouflaging physical items are provided. The camouflage system for securement to a physical item can include a substrate layer having a front surface and a camouflage pattern on the front surface. One or more micro-terrain layers can be disposed over the camouflage pattern and the front surface of substrate layer forming at least a portion of an outer surface of the camouflage system to form a frictional contact surface.

### RELATED APPLICATION

This application claims the benefit of U.S. Provisional Patent Application Ser. Nos. 61/262,588, filed Nov. 19, 2009, and 61/343,978, filed May 6, 2010, with the entire contents of both being hereby incorporated by reference herein. Further, this application is a continuation-in-part patent application which claims the benefit of the filing date of U.S. patent application Ser. No. 12/386,986, filed Apr. 24, 2009, the disclosure of which is incorporated herein by reference in its entirety.

### TECHNICAL FIELD

The presently disclosed subject matter relates generally to camouflaging and improving traction, such as hand grip and foot traction, on physical items. More particularly, the present subject matter relates to systems, kits, and methods for applying a polymer wrap material such as vinyl film to a physical item, such as a weapon, a vehicle, military hardware, military equipment, or other military accessories to provide visual, thermal and/or radar camouflage and improve handling of the physical item by personnel.

### BACKGROUND

In war, the function of camouflage is very simple: it is used to hide individuals and their equipment from the enemy. People have been using camouflage in some form or another from the beginning of human civilization. In fact, the basic idea of camouflage predates humans entirely. It comes from the natural adaptations that let animals blend in with their environment. Generally, camouflage material is colored with dull hues that match the predominant colors of the surrounding environment. In jungle warfare, camouflage is typically green and brown, to match the forest foliage and dirt. In the desert, military forces use a range of tan colors. Camouflage for snowy climates is colored with whites and grays. Thus, different manners of providing visual camouflage, concealment and deception have arisen.

Since World War II, tactical camouflage, concealment and deception designers have been forced to create solutions that addressed more than the visible spectrum of detection. This evolution is a result of increasingly sensitive sensor devices and technologies that have been developed over time. These sensor devices have included such divergent means as: enhanced optical range through advanced visual scopes, radar, night vision, and thermal imagery detection. Further, advances have led to technologies like forward looking infrared (“FLIR”) imaging technology and shortwave infrared (“SWIR”) sensing technologies that make invisible spectrum detection even better. Technologies and products are now merging these various sensor technologies together. A need has thus arisen for providing technologies that suppress such sensor technologies to provide tactical camouflage, concealment and deception.

Further, for many military applications, the type of material used to create the camouflage can create a surface that may be slick or at least harder to grasp when in use, especially when shoes and hands get wet due to perspiration or environmental conditions. Such surfaces can result in slipping off of, dropping or mishandling of the physical item that is camouflaged during operations. This need for having a surface that can be securely grasped in military operations is especially heightened in environments where the action is fast paced. These issues can be exacerbated by the hands' natural surface, and sweat and oils that are produced, and can also accumulate during handling, transport, or operation (especially in warm or humid environments and during prolonged periods of operation or portability). The gripping surface for the physical items used in military operations can often lead to unfortunate accidents where equipment is dropped or personnel cannot adequately hold onto a vehicle if there is not enough traction where the personnel engages the physical item.

In the past, tactical and military physical items that required precise digital camouflage specific to an area of operation, frictional surface for grasping the physical item, and/or multi-spectral signature suppression qualities, the military was forced to choose which problem to solve rather than solving multiple of these problems.

### SUMMARY

In accordance with this disclosure, systems, kits and methods for camouflaging physical items are provided. For example, a camouflage system can be provided that comprises a substrate layer having a camouflage pattern on a front surface of the substrate layer and one or more micro-terrain layers disposed over the camouflage pattern and substrate layer to form at least a portion of an outer surface of the camouflage system to form a frictional contact surface.

This and other objects of the present disclosure as can become apparent from the present disclosure are achieved, at least in whole or in part, by the subject matter described herein.

### BRIEF DESCRIPTION OF THE DRAWINGS

A full and enabling disclosure of the present subject matter including the best mode thereof to one of ordinary skill in the art is set forth more particularly in the remainder of the specification, including reference to the accompanying figures, in which:

FIGS. 1A-1H illustrate schematic views of embodiments of a multi-layered visual camouflage system with thermal and radar suppression according to the present subject matter;

FIGS. 2A-2B illustrate schematic views of other embodiments of a multi-layered visual camouflage system with thermal and radar suppression according to the present subject matter;

FIGS. 3A-3E illustrate schematic views of further embodiments of a multi-layered visual camouflage system with thermal and radar suppression according to the present subject matter;

FIG. 4 illustrates a magnified portion of an embodiment of a micro-terrain layer that can be used in a camouflage system according to the present subject matter;

FIGS. 5A-5C illustrate schematic views of further embodiments of a camouflage system according to the present subject matter;

FIGS. 6A-6C illustrate schematic views of further embodiments of a camouflage system according to the present subject matter;

FIG. 7 illustrates an embodiment of a kit containing components used to camouflage physical items, such as weapons and accessories according to the present subject matter;

FIG. 8 illustrates another embodiment of a kit containing components used to camouflage physical items, such as weapons and accessories according to the present subject matter;

FIG. 9 illustrates an embodiment of a camouflage panel and a stock of a weapon that can be wrapped by the camouflage panel according to the present subject matter;

FIG. 10 illustrates embodiments of steps for applying a camouflage panel to a weapon according to the present subject matter;

FIG. 11A-11C illustrates embodiments of other steps for applying a camouflage panel to a weapon according to the present subject matter;

FIG. 12 illustrates an embodiment of a weapon camouflaged according to the present subject matter; and

FIG. 13 illustrates an embodiment of a vehicle camouflaged according to the present subject matter pointing to areas where embodiments of a micro-terrain layer are or can be applied.

### DETAIL DESCRIPTION

Reference will now be made in detail to the description of the present subject matter, one or more examples of which are shown in the figures. Each example is provided to explain the subject matter and not as a limitation. In fact, features illustrated or described as part of one embodiment can be used in another embodiment to yield still a further embodiment. It is intended that the present subject matter cover such modifications and variations.

“Site-specific” as used herein means a specific local terrain, nautical position, or airspace where a physical item will be located or operating, or the environmental characteristics which would be found in the intended operating environment of the physical item.

“Pattern” as used herein means any color and/or imagery, including, but not limited to camouflage patterns, repeating and non-repeating designs, deceptive designs, such as imagery that give the perception that a vehicle is an ambulance, taxi, police vehicle, or the like, and outward physical characteristics of a physical item such as rust, dents scratches, or the like, printed to a vinyl adhesive layer.

“Disruptive pattern” as used herein means a pattern of shapes that when configured on an image will cause visual confusion.

“Distortions,” “distorting,” and variations thereof as used herein means the changing of at least a portion of an image by manipulating the focal lengths within those portions of the image, adding to a first image a portion of the image or a portion of different image that has a different focal length than the first image, or adding shapes of color that change the appearance of the image. Focal lengths can include improper focal lengths that cause at least a portion of the image to appear to be out of focus.

“Focal lengths” as used herein means the distance at which an image will come into visual focus either by a human observer or through electronic, electromechanical and/or optical methods and devices. Focal lengths can include improper focal lengths that cause at least a portion of the image to appear to be out of focus.

“Image-editing program” as used herein means a computer program used to edit or change an image. Examples include Adobe PHOTOSHOP®, PAINT.NET® and PICASA®.

“Image” as used herein means the optical counterpart of an object or environment produced by graphical drawing by a person, a device (such as a computer) or a combination thereof. The optical counterpart of the object can also be produced by an optical device electromechanical device or electronic device. As used herein, “image” can be used to refer to a whole image, for example, a photographic image as taken by a photographic device, or a portion thereof.

“Physical item” as used herein can include, but is not limited to any and all types of vehicles (land, air and/or sea), aircraft, watercraft, structures, buildings, pipes and piping, equipment, weapons, hardware, and other items used for military or other purposes where camouflage can enhance its effective use or where the need for camouflage concealment or deception exists.

“Nanomaterial” as used herein means nano-scale technology, such as nanoparticles or clusters of nanoparticles. Nanoparticles behave as a whole unit in terms of its transport and properties. Nanomaterial can include but is not limited to aerogel in powder form, clusters of powdered aerogel, microspheres and clusters of microspheres.

Camouflage systems and methods that use a vinyl layer with a camouflage pattern printed thereon to provide visual camouflage, concealment and deception and include nanomaterials to provide suppression of radar and/or thermal signatures are described herein. Simultaneous visual camouflage, concealment and deception and suppression of the radar and thermal signature are accomplished by imagery and the use of nanomaterials. Such visual camouflage and thermal and radar suppression systems that incorporate a vinyl layer and nanomaterial into a light-weight application for vehicles (manned and unmanned, land, sea, and air), hardware, equipment and engineered structures can fulfill advanced counter-measure needs in response to the developing sensor technologies.

The visual camouflage system can provide at least one of thermal or radar suppression. The system can include a vinyl layer having a camouflage pattern on a front surface of the vinyl layer. The camouflage pattern can be a site-specific camouflage pattern. A laminate layer can be secured over the front surface of the vinyl layer with the laminate layer coating the camouflage pattern to provide protection to the camouflage pattern and strengthen the vinyl layer. One or more nanomaterials can be disposed on at least one of the vinyl layer, camouflage pattern, or the laminate to provide at least one of thermal or radar suppression.

The system with its nano-scale technology, ultra-light weight, and unique thin film (adhesive or non-adhesive) graphic vinyl based structure with visual camouflage thereon operates inter-dependently to provide simultaneous concealment, deception and thermal and radar suppression.

The advanced visual camouflage can be accomplished through the use of, for example, high megapixel digital photography that is specific to the intended site, mission environment, or area of operation. It is printed in high detail and at a high resolution by suitably large format printing means, such as inkjet technology onto a vinyl thin-film. This tactical vinyl graphic film can then have an over-laminate protective barrier with a low-gloss finish laminated thereto.

Thermal and radar signature suppression counter-measures can be embedded into or between layers of this ultra-thin, lightweight system in the form of nano-scale, air or gas-filled microspheres or micro-balloons that can also be metallic coated, such as cenospheres, and pulverized aerogels that consist of over 90% air in nano-scale pores that inhibit heat transfer with low density. These materials in combination with one another provide the mechanism for simultaneous visual camouflage and thermal and radar signature suppression.

Once the camouflage system is created, it can be applied to military and tactical vehicles (land, sea or air), military hardware, equipment and engineered structures through the use of adhesives. The adhesive may be applied to the vinyl film before or after the camouflage image is added. Alternatively, the camouflage system can be of a non-adhesive nature.

The visual camouflage can be provided by camouflage patterns. The camouflage patterns and processes can use photo-digital processes to create the camouflage patterns. These processes can seek to disrupt the normal environment of the site-specific photographs to disrupt vision rather than attempting to create a camouflage pattern to match the photograph. Also, the various camouflage patterns described herein can create distinct camouflage patterns for different or multiple visual angles or perspectives of the same object in order to maximize stealth or concealment from each angle. Rather than attempting to create a camouflage pattern that is realistic or similar to what is displayed in a photograph, the camouflage patterns described herein can distort the image to disrupt vision thereby making the camouflage pattern more effective.

The nanomaterials used in the camouflage system can include aerogels and microspheres. Aerogels that can be used in the camouflage system are solid-state materials with very low densities. Aerogels describe a class of material based upon their structure, namely low density, open cell structures, large surface areas (often 900 m²/g or higher) and sub-nanometer scale pore sizes. Supercritical and subcritical fluid extraction technologies are commonly used to extract the fluid from the fragile cells of the material. A variety of different aerogel compositions are known and may be inorganic or organic. Inorganic aerogels are generally based upon metal alkoxides and can include but are not limited to materials such as silica, carbides, and alumina. Organic aerogels include carbon aerogels and polymeric aerogels such as polyimides.

Aerogels can be derived from a gel in which the liquid component of the gel has been replaced with gas. The result is an extremely low-density solid with several remarkable properties, most notably its effectiveness as a thermal insulator. Aerogels are good thermal insulators. As stated above, the aerogels can include silicon, carbon and metallic aerogels, such as alumina aerogels. Silica aerogels can be a good conductive insulator because silica is a poor conductor of heat. A metallic aerogel, on the other hand, may be a less effective insulator. Carbon aerogel is a good radiative insulator because carbon absorbs the infrared radiation that transfers heat at standard temperatures. Another good insulative aerogel is silica aerogel with carbon added to it.

When incorporated into a camouflage system described herein and the camouflage system is secured around a physical item, such insulative aerogels can provide good suppression of the thermal signature of the physical item. The aerogels can be pulverized into a powder form and embedded into a vinyl layer during manufacturing of the layer. The aerogels can contain particles ranging in size between about 1 to 10 nm, for instance about 2 to about 5 nm, that are generally fused into clusters. Alternatively, the aerogels can be included in the adhesives, inks, or laminate layer used on the vinyl layer. The inclusion of the aerogels, even in their pulverized or powder form, in the camouflage system can facilitate thermal suppression in the system and may improve radar suppression as well.

Similarly, microspheres can be included in the camouflage system. Microspheres are hollow microsphere particles that can be made from metal (e.g., gold), metal oxides (e.g., Al₂O₃, TiO₂, ZrO₂), silica, or the like. Microspheres can be fabricated with various diameters and wall thicknesses.

The microspheres can include glass microspheres and cenospheres. Hollow glass microspheres, sometimes termed microballoons, have diameters ranging from about 10 to about 300 micrometers. A cenosphere is a lightweight, inert, hollow sphere filled with inert air or gas, typically produced as a byproduct of coal combustion at thermal power plants. The color of cenospheres varies from gray to almost white and their density is about 0.4-0.8 g/cm³, which gives them great buoyancy. Cenospheres are hard and rigid, light, waterproof, innoxious, and insulative.

When incorporated into a camouflage system described herein and the camouflage system is secured around a physical item, microspheres such as those described above, including glass, ceramics, and/or alumina silicate, can provide good suppression of the radar signature of the physical item. These microspheres can be embedded into the vinyl layer during manufacturing of the layer. Alternatively, the microspheres can be included in the adhesives, inks, or over-laminate used on the vinyl layer. The microspheres can contain particles ranging in size between about 10 to 300 micrometers, for example about 10 to about 20 micrometers. The microspheres can be generally fused into clusters. The microspheres separately and in clusters reflect waves in irregular or dispersed fashion to make a wave signature hard to detect. Thus, the inclusion of the microspheres in the camouflage system facilitates radar suppression and may improve thermal suppression in the system.

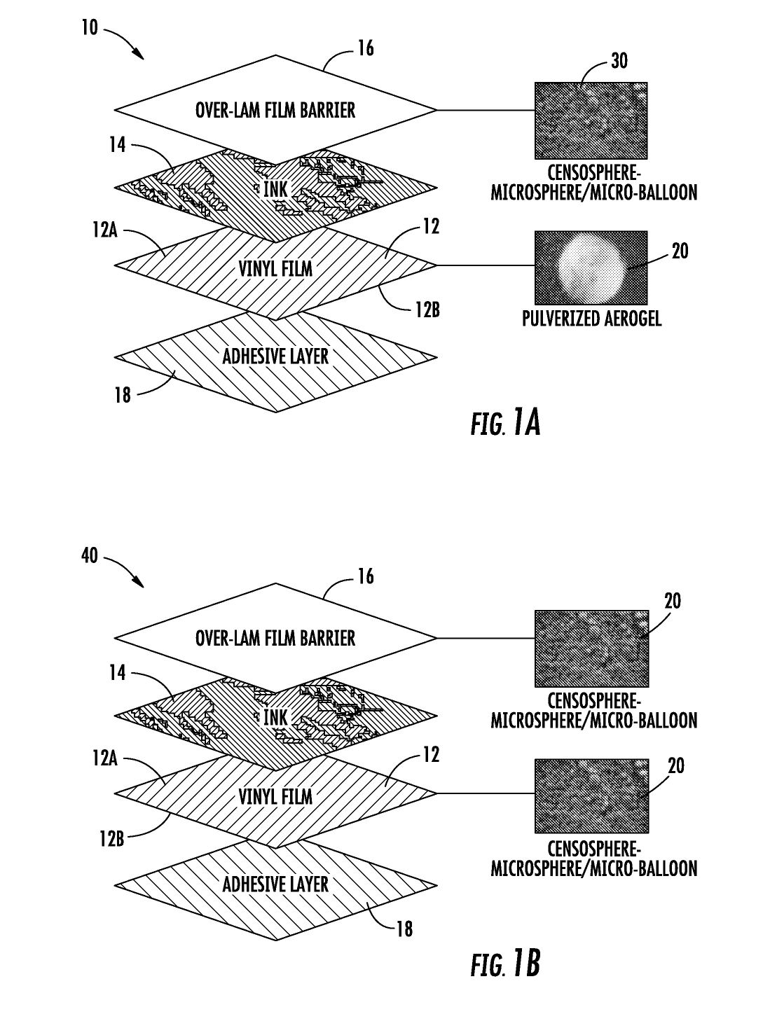

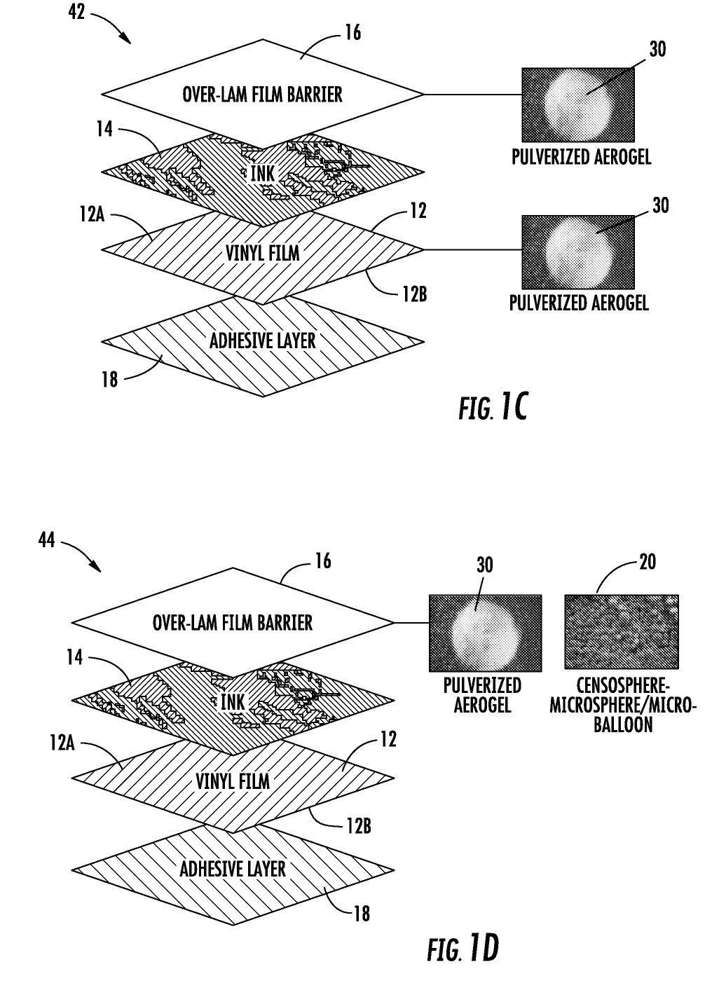

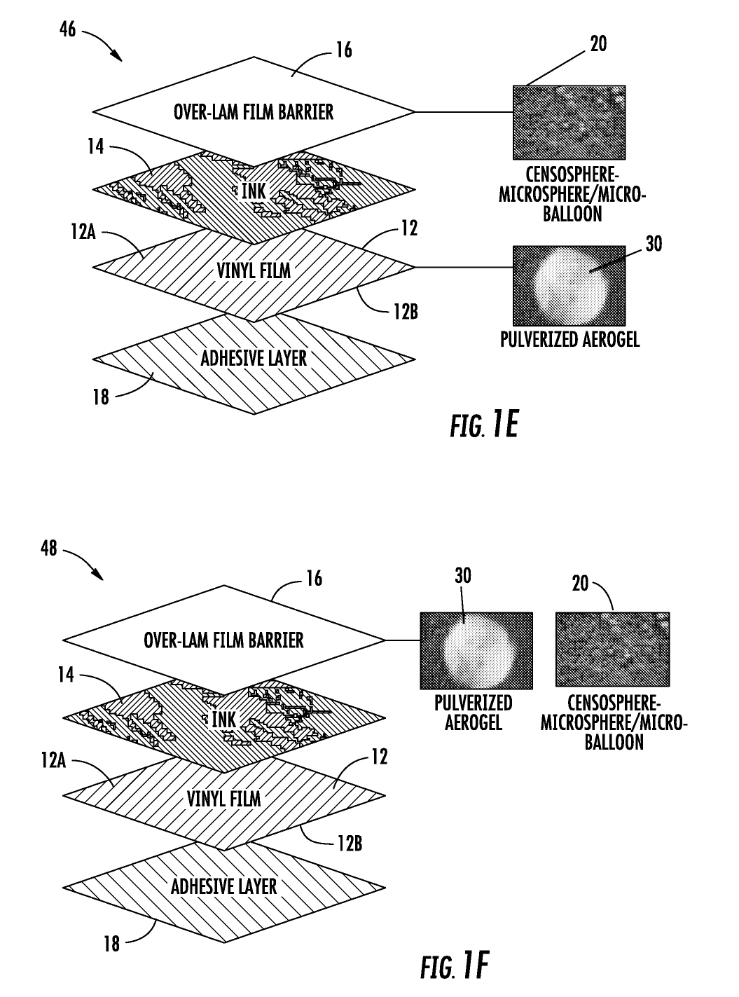

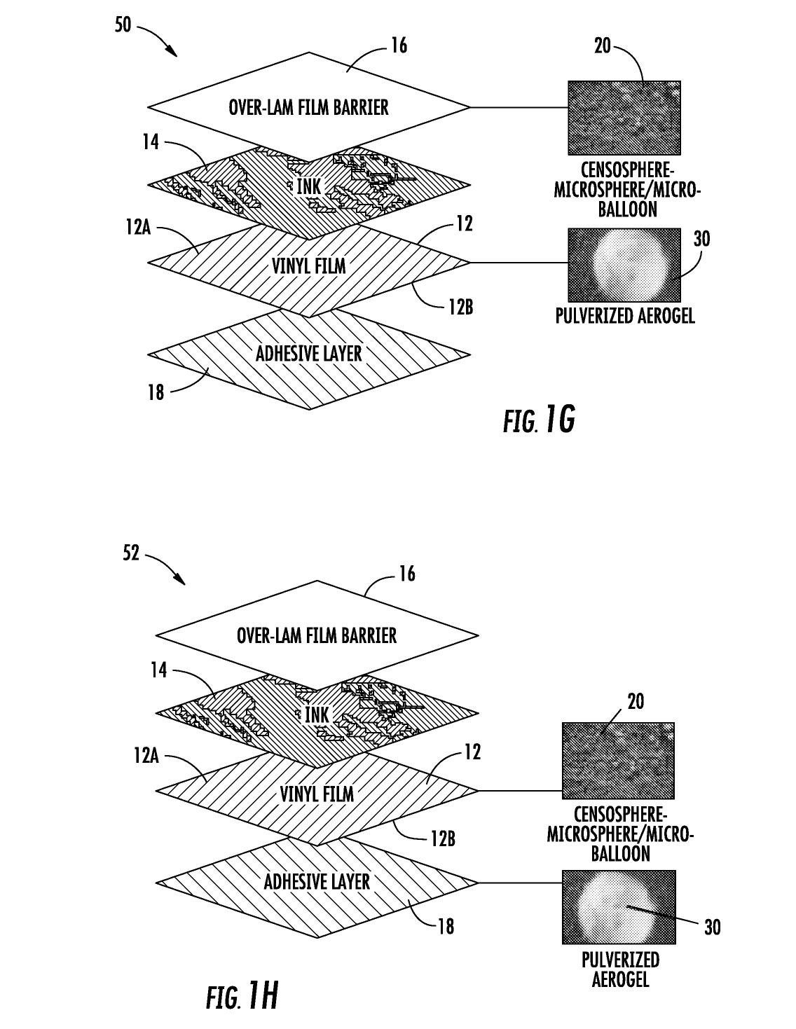

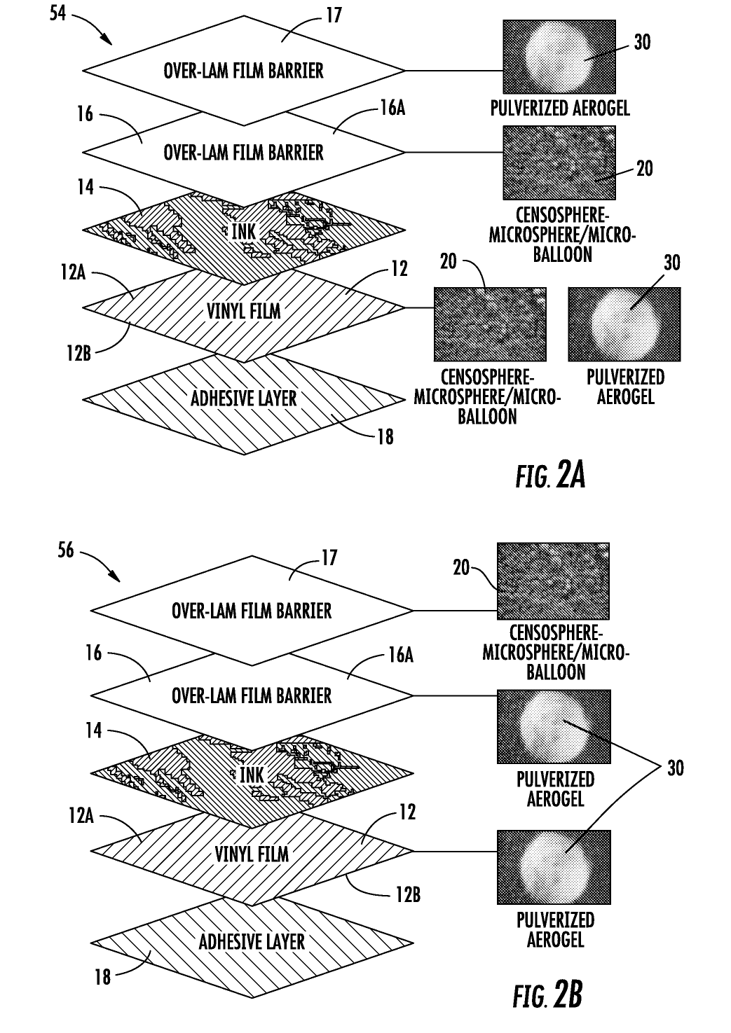

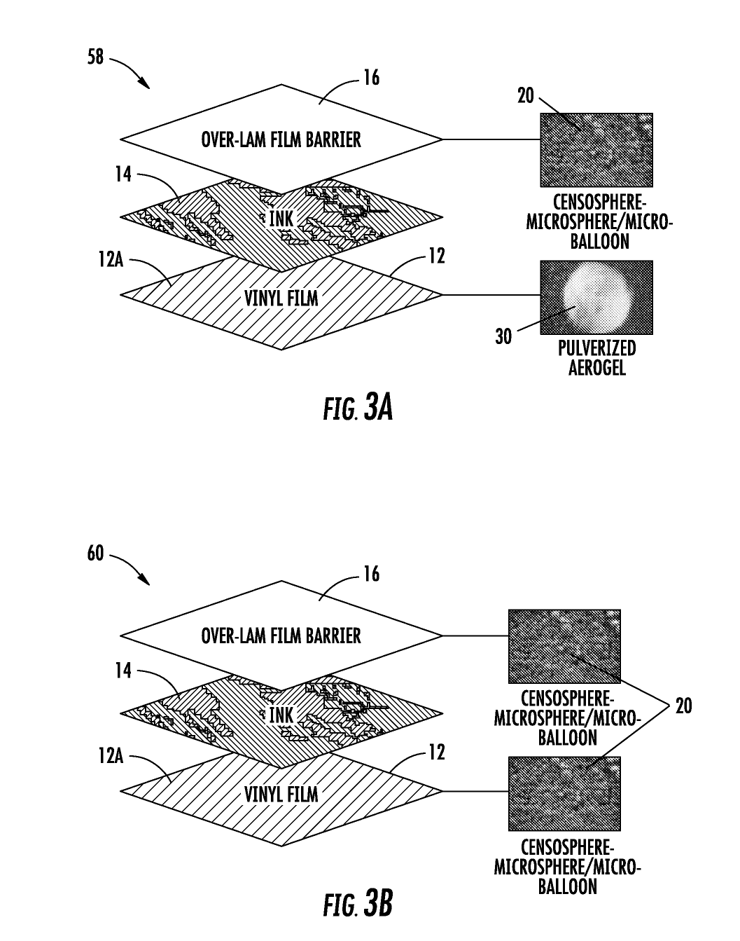

FIGS. 1A-1H, 2A-2B, and 3A-3E illustrate different embodiments of a visual camouflage system. A vinyl layer 12 can be provided. The vinyl layer 12 can have a front surface 12A and a back surface 12B. The back surface 12B can be on the surface opposite the front surface 12A. A camouflage pattern 14 can be printed on the front surface 12A of the vinyl layer 12. The camouflage pattern 14 can be a site-specific image as explained in more detail below. A first laminate layer 16 can be secured over the front surface 12A of the vinyl layer 12 with the laminate layer 16 coating the camouflage pattern 14 to provide protection to the camouflage pattern 14 and strengthen the vinyl layer 12. One or more nanomaterials 20, 30 can be disposed on at least one of the vinyl layer 12, camouflage pattern 14, or the laminate 16 to provide thermal and/or radar suppression.

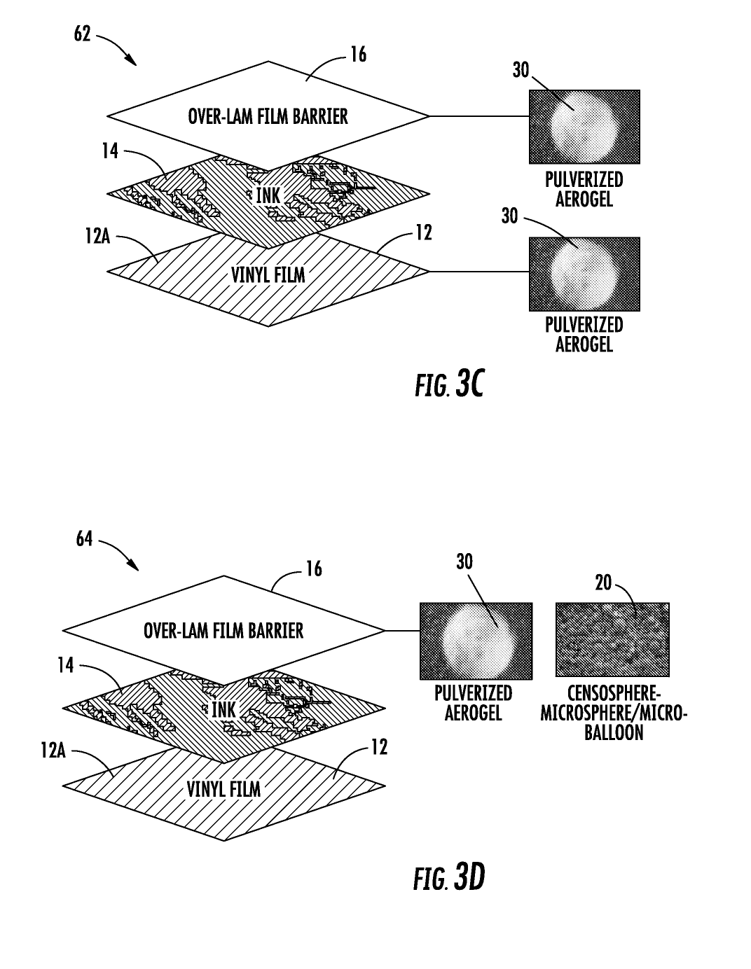

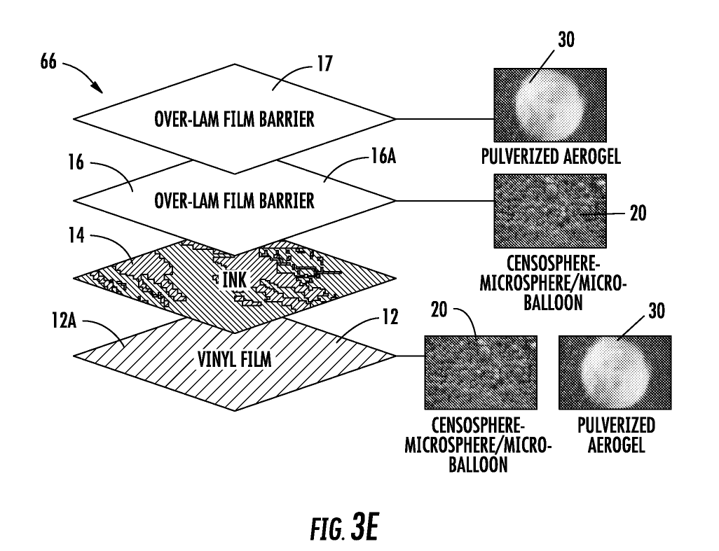

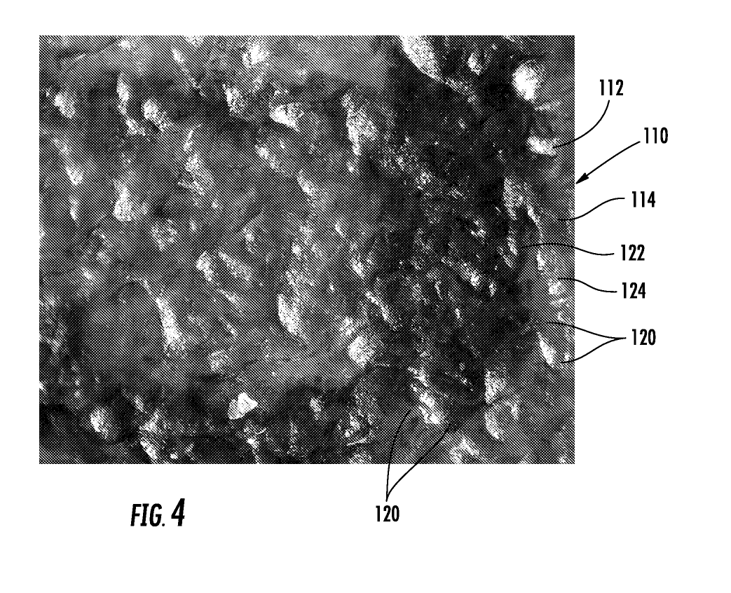

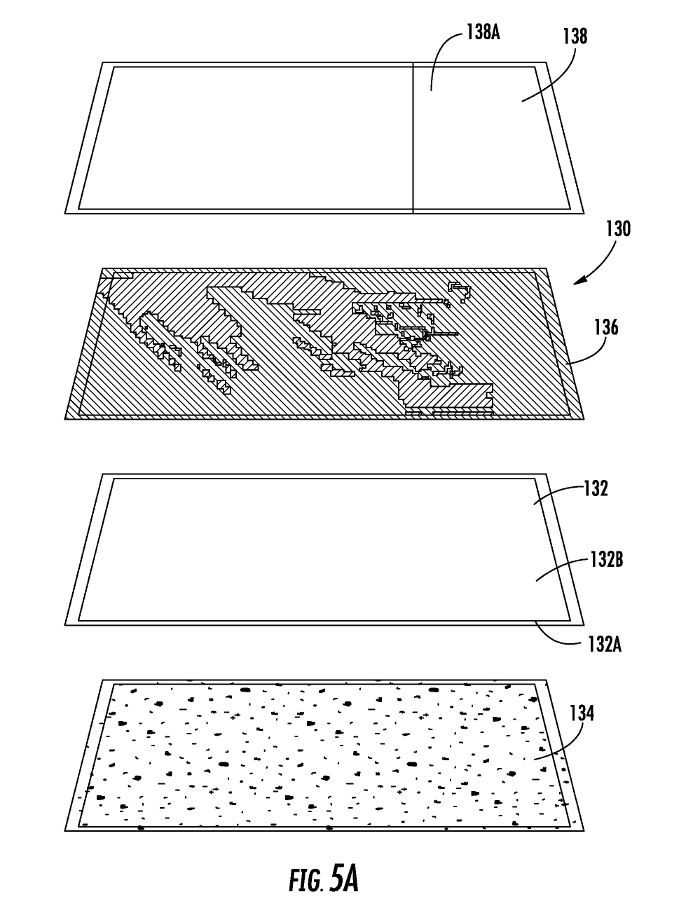

As shown in FIGS. 2A-2B and 3E, a second laminate layer 17 can be disposed on a surface 16A of the first laminate layer 16 opposite the surface on which the camouflage pattern 14 and vinyl layer 12 are secured. This front surface 16A of the first laminate layer 16 faces outward from the vinyl layer 12. Also, as shown in FIGS. 1A-1H and 2A-2B, an adhesive layer 18 can be applied on a surface 12B of the vinyl layer 12 opposite the front surface 12A on which the camouflage pattern 14 is disposed.

The nanomaterials 20, 30 can comprise a first nanomaterial or a second nanomaterial that provide thermal and/or radar suppression to the physical item to which the camouflage system is applied. For example, the nanomaterial 20 can comprise microspheres as described in detail above. Similarly, the nanomaterial 30 can comprise an aerogel as described in detail above. In some embodiments, it is preferably to have the microspheres in a layer above the aerogel such that the microspheres are closer to the outside environment instead of the physical item to which the camouflage system is attached.

As described in more detail below, one or both of the nanomaterials 20, 30 can be disposed on the vinyl layer 12. The deposition of the nanomaterials 20, 30 onto (for example, embedded in) a surface 12A, 12B of the vinyl layer can be performed by a sputtering deposition. Alternatively, one or both of the nanomaterials 20, 30 can be mixed into a vinyl material used to create the vinyl layer 12 before the vinyl layer 12 is formed. Similarly, one or both of the nanomaterials 20, 30 can be disposed on the laminate layer 16. The deposition of the nanomaterials 20, 30 onto (for example, embedded in) a surface of the laminate layer 16 can be performed by a sputtering deposition.

Alternatively, one or both of the nanomaterials 20, 30 can be mixed into a laminate material used to create the laminate layer 16 before the laminate layer 16 can be formed. Also, at least one of the nanomaterials 20, 30 can be disposed on the second laminate layer 17 as described above regarding the first laminate layer 16 when a second laminate layer 17 is used (See FIGS. 2A-2B and 3E).

Further, the camouflage pattern 14, which can comprises ink, can include one or both of the nanomaterials 20, 30. When including the nanomaterials 20, 30 in the ink, the ink can take longer to set. For example, one or both of the nanomaterials 20, 30 can be mixed into the ink before printing of the camouflage pattern 14 onto the vinyl layer 16. Similarly, the adhesive layer 18 can include one or both of the nanomaterials 20, 30. For example, one or both of the nanomaterials 20, 30 can be mixed into the adhesive used to create the adhesive layer 18 before application of the adhesive layer 18 onto the vinyl layer 12.

FIG. 1A illustrates an embodiment of a camouflage system 10 that can provide suppression for both the thermal signature and the radar signature of the physical item to which it is attached. The camouflage system 10 can have a vinyl layer 12 with a front surface 12A on which a site-specific camouflage pattern 14 is printed. A laminate layer 16 can be secured overtop of the camouflage pattern 14 and the vinyl layer 12. An adhesive layer 18 can be secured on the back surface 12B opposite the front surface 12A of the vinyl layer 12. A nanomaterial 30 in the form of an aerogel in powder form, i.e., a pulverized aerogel, can be included in the vinyl layer 12 to provide thermal insulation and suppression of the thermal signature of the physical item to which the camouflage system 10 is attached. A nanomaterial 20 in the form of microspheres can be included in the laminate layer 16 to provide suppression of the radar signature of the physical item to which the camouflage system 10 is attached.

Depending on the type of physical item that is being camouflaged and the environment in which it operates, the need for different types of signature suppression may vary. For example, for certain types of manned or unmanned aircraft, radar suppression may be more important that thermal suppression. FIG. 1B illustrates another embodiment of a camouflage system 40 that can provide more suppression for the radar signature of the physical item to which it is attached. The camouflage system 40 can have a vinyl layer 12 with a front surface 12A on which a site-specific camouflage pattern 14 is printed. A laminate layer 16 can be secured overtop of the camouflage pattern 14 and the vinyl layer 12. An adhesive layer 18 can be secured on the back surface 12B opposite the front surface 12A of the vinyl layer 12 for attachment of the camouflage system 40 to a physical item. In camouflage system 40, a nanomaterial 20 in the form of microspheres can be included in both the vinyl layer 12 and the laminate layer 16 to provide suppression of the radar signature of the physical item to which the camouflage system 40 is attached.

In another example, for certain types of manned or unmanned land vehicles, thermal suppression may be more important that radar suppression.

FIG. 1C illustrates another embodiment of a camouflage system 42 that can provide more suppression for the thermal signature of the physical item to which it is attached. The camouflage system 42 can have a vinyl layer 12 with a front surface 12A on which a site-specific camouflage pattern 14 is printed. A laminate layer 16 can be secured overtop of the camouflage pattern 14 and the vinyl layer 12. An adhesive layer 18 can be secured on the back surface 12B opposite the front surface 12A of the vinyl layer 12 for attachment of the camouflage system 42 to a physical item. In camouflage system 42, a nanomaterial 30 in the form of an aerogel in powder form can be included in both the vinyl layer 12 and the laminate layer 16 to provide suppression of the thermal signature of the physical item to which the camouflage system 42 is attached.

FIG. 1D illustrates an embodiment of a camouflage system 44 that can provide suppression for both the thermal signature and the radar signature of the physical item to which it is attached. The camouflage system 44 can have a vinyl layer 12 with a front surface 12A on which a site-specific camouflage pattern 14 is printed. A laminate layer 16 can be secured overtop of the camouflage pattern 14 and the vinyl layer 12. An adhesive layer 18 can be secured on the back surface 12B opposite the front surface 12A of the vinyl layer 12 for attachment of the camouflage system 44 to a physical item. A nanomaterial 20 in the form of microspheres and a nanomaterial 30 in the form of an aerogel in powder form can be included in the laminate layer 16 to provide suppression of the radar signature and suppression of the thermal signature of the physical item to which the camouflage system 44 is attached.

FIG. 1E illustrates another embodiment of a camouflage system 46 that can provide suppression for both the thermal signature and the radar signature of the physical item to which it is attached. The camouflage system 46 can have a vinyl layer 12 with a front surface 12A on which a site-specific camouflage pattern 14 is printed. A laminate layer 16 can be secured overtop of the camouflage pattern 14 and the vinyl layer 12. An adhesive layer 18 can be secured on the back surface 12B opposite the front surface 12A of the vinyl layer 12 for attachment of the camouflage system 46 to a physical item. A nanomaterial 30 in the form of an aerogel in powder form can be included in the ink of the camouflage pattern 14 to provide suppression of the thermal signature of the physical item to which the camouflage system 46 is attached. A nanomaterial 20 in the form of microspheres can be included in the laminate layer 16 to provide suppression of the radar signature of the physical item to which the camouflage system 46 is attached.

FIG. 1F illustrates a further embodiment of a camouflage system 48 that can provide suppression for both the thermal signature and the radar signature of the physical item to which it is attached. The camouflage system 48 can have a vinyl layer 12 with a front surface 12A on which a site-specific camouflage pattern 14 is printed. A laminate layer 16 can be secured overtop of the camouflage pattern 14 and the vinyl layer 12. An adhesive layer 18 can be secured on the back surface 12B opposite the front surface 12A of the vinyl layer 12 for attachment of the camouflage system 48 to a physical item. A nanomaterial 20 in the form of microspheres and a nanomaterial 30 in the form of an aerogel in powder form can be included in the vinyl layer 12 to provide suppression of the radar signature and suppression of the thermal signature of the physical item to which the camouflage system 48 is attached.

FIG. 1G illustrates another embodiment of a camouflage system 50 that can provide suppression for both the thermal signature and the radar signature of the physical item to which it is attached. The camouflage system 50 can have a vinyl layer 12 with a front surface 12A on which a site-specific camouflage pattern 14 is printed. A laminate layer 16 can be secured overtop of the camouflage pattern 14 and the vinyl layer 12. An adhesive layer 18 can be secured on the back surface 12B opposite the front surface 12A of the vinyl layer 12 for attachment of the camouflage system 50 to a physical item. A nanomaterial 20 in the form of microspheres can be included in the ink of the camouflage pattern 14 to provide suppression of the radar signature of the physical item to which the camouflage system 50 is attached. A nanomaterial 30 in the form of an aerogel in powder form can be included in the vinyl layer 12 to provide suppression of the thermal signature of the physical item to which the camouflage system 50 is attached.

FIG. 1H illustrates an embodiment of a camouflage system 52 that can provide suppression for both the thermal signature and the radar signature of the physical item to which it is attached. The camouflage system 52 can have a vinyl layer 12 with a front surface 12A on which a site-specific camouflage pattern 14 is printed. A laminate layer 16 can be secured overtop of the camouflage pattern 14 and the vinyl layer 12. An adhesive layer 18 can be secured on the back surface 12B opposite the front surface 12A of the vinyl layer 12 for attachment of the camouflage system 52 to a physical item. A nanomaterial 20 in the form of microspheres can be included in the vinyl layer 12 to provide suppression of the radar signature of the physical item to which the camouflage system 52 is attached. A nanomaterial 30 in the form of an aerogel in powder form can be included in the adhesive layer 18 to provide suppression of the thermal signature of the physical item to which the camouflage system 52 is attached.

FIGS. 2A and 2B illustrate embodiments of camouflage systems 54 and 56 that are similar to some of the embodiments described above in that they can provide suppression for both the thermal signature and the radar signature of the physical item to which they are attached. The camouflage systems 54, 56 can have a vinyl layer 12 with a front surface 12A on which a site-specific camouflage pattern 14 is printed. A first laminate layer 16 can be secured overtop of the camouflage pattern 14 and the vinyl layer 12. Further, a second laminate layer 17 can be secured on a front surface 16A of the first laminate layer 16. An adhesive layer 18 can be secured on the back surface 12B opposite the front surface 12A of the vinyl layer 12 for attachment of the respective camouflage systems 54, 56 to a physical item.

In the camouflage system 54 in FIG. 2A, a nanomaterial 20 in the form of microspheres can be included in the first laminate layer 16 and the vinyl layer 12 to provide suppression of the radar signature of the physical item to which the camouflage system 54 is attached. Similarly, for camouflage system 54, a nanomaterial 30 in the form of an aerogel in powder form can be included in the second laminate layer 17 and the vinyl layer 12 to provide suppression of the thermal signature of the physical item to which the camouflage system 54 is attached.

In the camouflage system 56 in FIG. 2B, a nanomaterial 20 in the form of microspheres can be included in the second laminate layer 17 to provide suppression of the radar signature of the physical item to which the camouflage system 56 is attached. Similarly, for camouflage system 56, a nanomaterial 30 in the form of an aerogel in powder form can be included in the first laminate layer 16 and the vinyl layer 12 to provide thermal insulation and suppression of the thermal signature of the physical item to which the camouflage system 56 is attached.

FIGS. 3A-3B illustrate embodiments of camouflage systems 58, 60, 62, 64, and 66 that are similar to some of the embodiments illustrated in FIGS. 1A-1H except they do not include an adhesive layer. In FIG. 3A, camouflage system 58 provides both thermal and radar suppression. In camouflage system 58, a nanomaterial 30 in the form of an aerogel in powder form, i.e., a pulverized aerogel, can be included in the vinyl layer 12 to provide thermal insulation and thermal suppression. Also, a nanomaterial 20 in the form of microspheres can be included in the laminate layer 16 to provide radar suppression.

FIG. 3B illustrates another embodiment of a camouflage system 60 that can provide more radar suppression. In camouflage system 60, a nanomaterial 20 in the form of microspheres can be included in both the vinyl layer 12 and the laminate layer 16 to provide radar suppression. Conversely, FIG. 3C illustrates another embodiment of a camouflage system 62 that can provide more thermal suppression. In camouflage system 62, a nanomaterial 30 in the form of an aerogel in powder form can be included in both the vinyl layer 12 and the laminate layer 16 to provide thermal suppression.

In FIG. 3D, camouflage system 64 provides both thermal and radar suppression. In camouflage system 64, a nanomaterial 20 in the form of microspheres and a nanomaterial 30 in the form of an aerogel in powder form can be included in the laminate layer 16 to provide radar suppression and thermal suppression. In FIG. 3E, camouflage system 66 also provides both thermal and radar suppression. In camouflage system 66, a nanomaterial 20 in the form of microspheres can be included in the second laminate layer 17 and the vinyl layer 12 to provide radar suppression. Similarly, for camouflage system 66, a nanomaterial 30 in the form of an aerogel in powder form can be included in the first laminate layer 16 and the vinyl layer 12 to provide thermal suppression.

The processes for creating the layers of the camouflage system are described in more detail below. An example of a vinyl layer that can be used is a polyvinyl chloride (“PVC”) film on which a camouflage pattern can be printed. For such a film, the conditions in the printing area are preferably controlled. For example, the room temperature and relative humidity can be between about 60° F. to about 90° F. and the relative humidity can be between about 50% to about 90% RH. For instance, the temperature and relative humidity can be about 73° F. (23° C.) and 50% RH when using as a substrate a 2.7 mil gloss white, polymeric stabilized, soft calendared PVC film designed for receiving digital ink jet printers. The ink used can be printing inks such as digital printing inks. Different inks can be used to ascertain different properties in the final product. The substrate used can be coated on one side, or surface with a permanent, opaque, acrylic, pressure sensitive adhesive with air egress technology and supplied with a 80# poly coated liner that is used as a release liner to protect the adhesive until time for application. Below is a list of physical properties of an example acrylic adhesive that can be applied to a substrate such as the PVC film described above.

TABLE 1
Properties of an Example Pressure Adhesive

| | | Test Method |
|---|---|---|
| | | (Federal Test |
| | | Methods |
| Physical Properties | Typical Values | used) |
| Peel Adhesion, lb./in. | about 3.2-about 4.6 | FTM-1 |
| (N/25 mm) | (about 14-20) | |
| 180 degrees on glass-24 hr | | |
| Quick Tack on Glass lb./in. | about 3.4-about 4.8 | FTM-9 |
| (N/25 mm) | (about 15-about 21) | |
| Dimensional Stability, (%) | Maximum of about 0.5 | FTM-14 |
| 10″ by 10″ sample bonded | | |
| to Aluminum | | |
| Normal Application | Above about 50° F. | |
| Temperature and | (about +10° C.) | |
| Temperature Ranges for | About −40° F. to about | |
| Minimum Application | 194° F. (about −40° C. | |
| | to about 90° C.) | |

Once the camouflage pattern is printed on the vinyl layer, the vinyl layer is laid on a drying table and left to “gas” or “dry” for a period of about 72 hours to ensure that the ink is dry. Once the layer has gone through the 72 hour period and depending on the end use of the layer, then it can be laminated in a lamination process to provide a laminate layer that overcoats the camouflage pattern and the vinyl layer. For example, for a layer of a PVC film to be used to cover a vehicle, the PVC film can be laminated. Laminating a layer like PVC film can add strength and protection to the printed image. For example, a laminate layer when bonded with the PVC film can provide protection to a vehicle on which it is applied (and any individuals inside) against chemical and biological agents and it can help protect the vehicle from corrosive agents as well. It can also be used to add gloss or a reflection control layer. In particular, the laminate layer can add non-shiny protection by being non-gloss or low gloss in nature.

The laminate layer used in such a lamination process can be a highly conformable cast film, such as a PVC film. Alternatively, it can be a polyester (PET) film that can range in thickness from about 0.5 mm to about 10 mm. For example, highly conformable cast film having thickness of about 1.5 mm can be used. A cast vinyl or PET laminate layer can have a built-in ultraviolet protection, be optically clear, and have a low gloss or no-gloss (flat) finish or matte. The laminate can include a permanent adhesive, such as an acrylic adhesive.

The vinyl layer with the camouflage pattern printed thereon and the laminate layer can be run through a lamination process where the adhesive side of the laminate faces the printed side of the substrate. The laminate layer and vinyl layer can then pass through pressurized heated or unheated rollers to secure the laminate layer to the vinyl layer. The laminate layer can be usable in temperatures from about 50° F. to about 225° F. Thus, the laminate layer can be applied to the vinyl layer in hot and cold applications. In the PVC film example, the vinyl layer can be left to cool after the material is laminated at about 120° F.

In another example, a 1.5-mil clear matte or a 1.5-mil clear gloss, which are highly conformable cast PVC films, can be chosen as the laminate layer. The over-laminate film is coated on one side with a clear permanent, acrylic pressure sensitive adhesive and supplied with a 1.2 mil polyester release liner. Upon application, the release liner can be removed. The vinyl layer with the camouflage pattern printed thereon and the laminate layer can be aligned so that the adhesive side of the laminate layer faces the printed side of the vinyl layer. The laminate layer and vinyl layer can then pass through pressurized rollers to secure the laminate layer to the vinyl layer. UV protection can incorporated into the laminate layer to help extend the life of the graphic by resisting color fade caused by ultraviolet light.

Suitable layers with the printed patterns described above that have a protective overcoating laminated thereto can provide excellent substrates to incorporate nanomaterials that can provide radar and/r thermal suppression as well. As mentioned above, nanomaterials such as appropriate aerogels and microspheres can be incorporated into different layer in different manners and at different stages described above. For example, each nanomaterial can be added to the laminate layers and vinyl layer on which the camouflage pattern is printed by a sputtering to randomly yet precisely dispose the nanomaterial on the respective layer. Alternatively, the nanomaterial(s) can be added to and mixed in with the material out of which the respective layers are made before the formation of the respective layers. Similarly, the nanomaterials can be added to the ink used to print the camouflage pattern on the vinyl layer or to the adhesive used in the adhesive layer by mixing the nanomaterials into either the ink or the adhesive before application on the vinyl layer. The amount of nanomaterial added to the camouflage system can vary. Also, the amount of nanomaterial added to the camouflage system can be customized to the application in which the camouflage system will be used or to the signature detection technology anticipated in the area of operation.

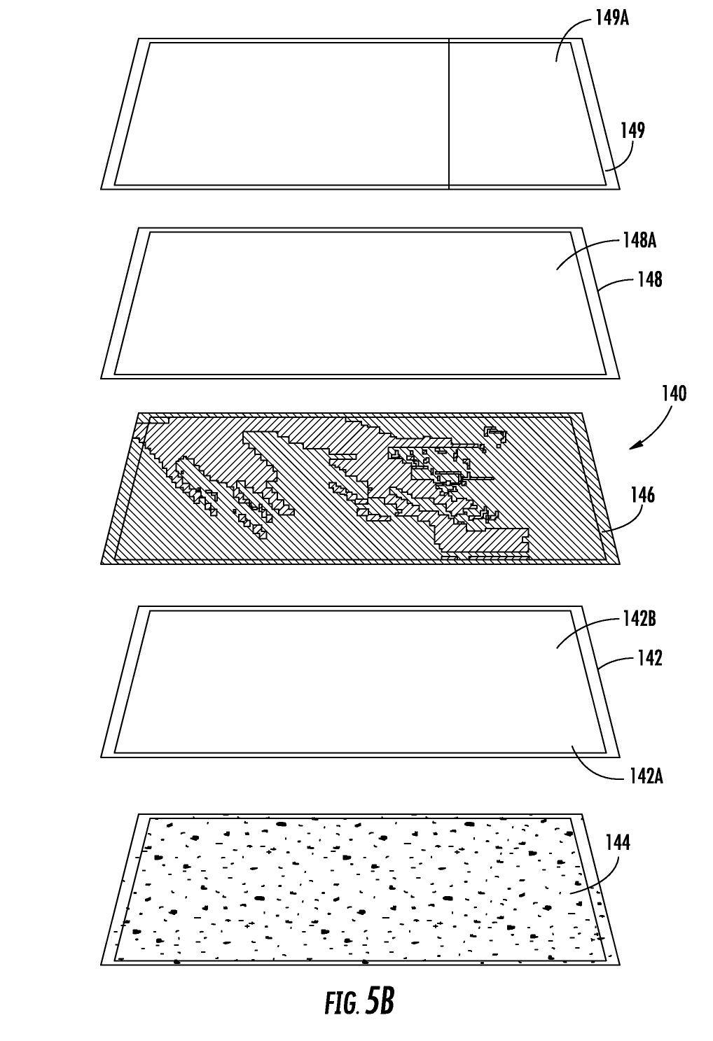

FIG. 4 illustrates a magnified view of a micro-terrain layer 110. Micro-terrain layer 110 can be transparent or semi-transparent. Alternatively, micro-terrain layer 110 can have a camouflage pattern printed or embedded therein. For example, micro-terrain layer 110 can be simultaneously coordinated with, and/or can be used to complete, a greater visual camouflage design pattern of a underlying design. Micro-terrain layer 110 can include microstructures 120 that roughen the surface of the layer 110 to create a frictional contact surface 112. The microstructures 120, for example, can create ridges 122 and valleys 124 on its outer surface 114 to create frictional contact surface 112. The outer surface 114 of micro-terrain layer 110 can be a soft pliable surface to increase the effectiveness of the ridges 122 and valleys 124 of the microstructures 120. The microstructures 120 of the micro-terrain can be filled with or can house and protect multi-spectral signature suppression materials therein.

In some embodiments, the placement and selection of micro-terrain layer 110 can be utilized to increase handheld and grasping traction. Selection of micro-terrain layer 110 relates to the type and sizes of microstructures 120 used in micro-terrain layer 110. Different sizes and shape of microstructures 120 and the material used to make them can affect the frictional traction that they can create. For example, the micro-terrain of the micro-terrain layer 110 can improve traction by diverting and removing sweat and oils within the micro-terrain, tractional grip can be maintained. For example, by increasing the differences in elevations in the microstructures 120 of the micro-terrain, further improvements for handheld traction can be achieved. The differences in the elevations create the cavities with the valleys 124 between the ridges 122 of the micro-terrain, for the accumulation of sweat and oils. In this way, advanced traction is achieved. Micro-terrain layer 110 can be used on the different embodiments of the camouflage systems shown in FIGS. 1A-3E. For example, micro-terrain layer 110 can be on the outermost laminate layer of the camouflage systems. Alternatively, micro-terrain layer 110 can form a portion of or the entire outermost laminate layer of the camouflage systems shown in FIGS. 1A-3E.

The micro-terrain layer 110 can feature oleophobic, hydrophobic, or oleophobic-hydrophobic coatings, itself. These coatings can be deposited in an organic solvent subtraction method at the upper elevations of outermost surface of the micro-terrain layer 110. An organic solvent subtraction method is a process of adding an organic solvent for later extraction, usually through evaporation. In this manner, coverage of a tablet device, improved grip, and oleophobic/hydrophobic or oleo-hydrophobic properties can be combined. This micro-terrain layer 110 can also be formed, for example, by either depositing on the PTFE film or embossing the PTFE film. Thus, the micro-terrain layer 110 can include microstructures that roughen the surface of the layer to create a frictional contact surface.

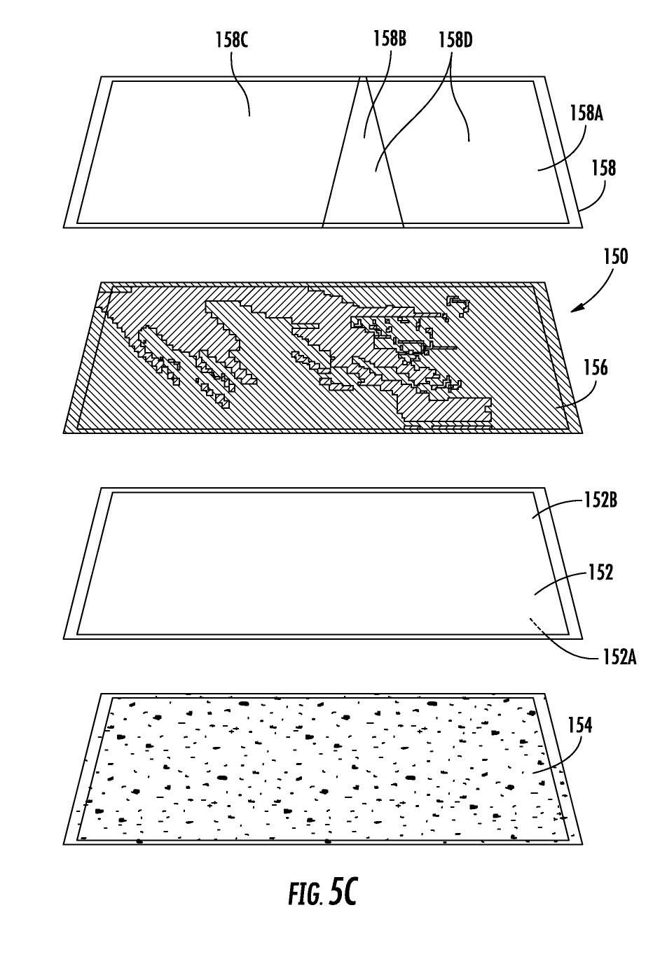

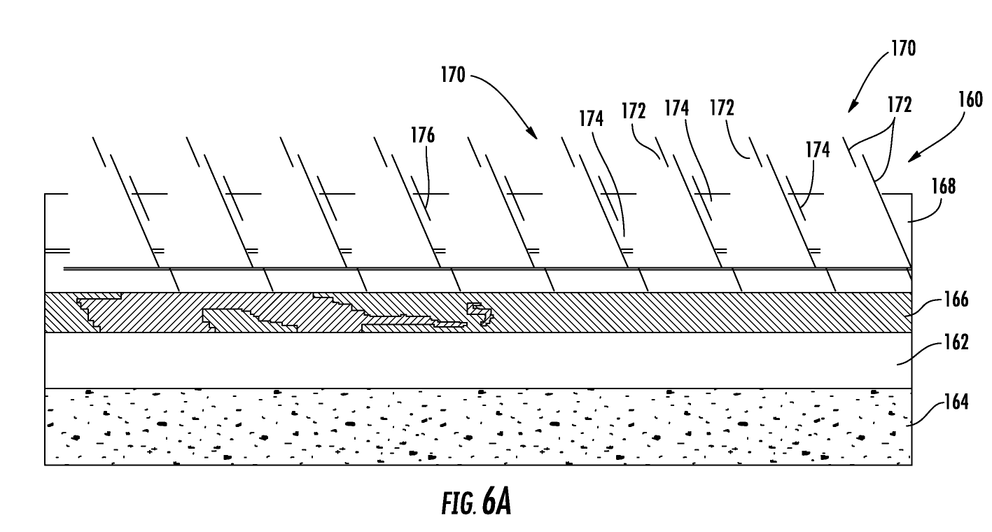

As shown in FIGS. 5A-5C, different embodiments of camouflage systems that can increase traction are shown. In FIG. 5A, a camouflage system, generally 130, is provided that has a strata structure of different layers. The camouflage system 130 can comprise a substrate layer 132 that can have an adhesive layer 134 on a back side, or surface, 132A of the substrate layer 132. A digitally printed layer 136 can be disposed on a front side, or surface, 132B of the substrate layer 132. A micro-terrain layer 138 can be disposed over the digitally printed layer 136 and substrate layer 132 and can serve as the outer layer of the camouflage system 130 to provide a frictional contact surface 138A. The digitally printed layer 136 can provide images useful for tactical, strategic or work-related purposes. In some embodiments, the different strata or layers 132, 134, 136, and 138 of the camouflage system 130 can include nanomaterials as described above with reference to FIGS. 1A-3E. Alternatively, in some embodiments, no such nanomaterial may be included in layers 132, 134, 136, and 138 of the camouflage system 130.

In FIG. 5B, another camouflage system, generally 140, is provided that has a strata structure of different layers. As above, the camouflage system 140 can comprise a substrate layer 142 that can have an adhesive layer 144 on a back surface 142A of the substrate layer 142. A digitally printed layer 146 can be disposed on a front surface 142B of the substrate layer 142. A laminate layer 148 can be disposed over the digitally print layer 146 and substrate layer 142. A micro-terrain layer 149 can be disposed over at least a portion of the front surface 148A of laminate layer 148. For example, micro-terrain layer 149 can be placed at selective locations on the laminate layer 148 where traction will be needed. The substrate layer 142, the print layer 146, the laminate layer 148 and as applicable the adhesive layer 144 can constitute a camouflage layer that can be applied to a physical item by itself with the micro-terrain layer 149 being applied later. Thus, the lower layers 142, 144, 146, and 148 can be used to form a camouflage layer without special traction enhancements and micro-terrain layer 149 can the placed at specific locations where traction is likely to be needed after the lower layers 142, 144, 146, and 148 of camouflage system 140 is secured on a physical item such as a weapon, vehicle, military equipment or hardware. Therefore, the micro-terrain layer 149 can selectively provide a frictional contact surface 149A. The digitally printed layer 146 can provide images useful for tactical, strategic or work-related purposes. In some embodiments, as above, the different strata or layers 142, 144, 146, 148, and 149 of the camouflage system 140 can include nanomaterials as described above with reference to FIGS. 1A-3E. Alternatively, in some embodiments, no such nanomaterial may be included in layers 142, 144, 146, 148, and 149 of the camouflage system 140.

In FIG. 5C, a different embodiment of camouflage system, generally 150, is provided that has a strata structure of different layers. As above, the camouflage system 150 can comprise a substrate layer 152 that can have an adhesive layer 154 on a back surface 152A of the substrate layer 152. A digitally printed layer 156 can be disposed on a front surface 152B of the substrate layer 152. A top layer 158 can be disposed over the digitally printed layer 156 and substrate layer 152. Top layer 158 can comprise one or more micro-terrain layer portions 158A, 158B and a traditional smooth laminate layer portion 158C. For example, micro-terrain layer portions 158A, 158B can be at selective locations in the top layer 158 where traction will be needed. Therefore, the micro-terrain layer portions 158A, 158B can selectively provide a frictional contact surface 158D at specific places on the outer surface of the camouflage system 150. The digitally printed layer 156 can provide images useful for tactical, strategic or work-related purposes. As above in some embodiments, the different strata or layers 152, 154, 156, and 158 of the camouflage system 150 can include nanomaterials as described above with reference to FIGS. 1A-3E. Alternatively, in some embodiments, no such nanomaterial may be included in layers 152, 154, 156, and 158 of the camouflage system 150.

Thus, as described above, the camouflage systems 130, 140, and 150 can be a multi-layered adhesive camouflage material featuring a micro-terrain layer 138, 149, and 158A and 158B in the outer-most physical strata or layer for increased friction with another contacting surface for improved performance, functionality or operation. The micro-terrain layers can be selectively placed on the surface of the digitally printed layer or laminate layer and the substrate layer so that frictional contact surfaces are only in positions where they are needed. This material can have an underlying digitally printed visual camouflage design layer that is printed on the substrate layer that allows for the completion or continuation of the same visual camouflage pattern between areas of frictional need and those areas without this need. For example, the digital printed layer can be a camouflage image that provides visual cover for a physical item when the physical item is used in a situational environment where the physical item and the user should blend therein. Each substrate layer can be a polymer-based film material with or without an adhesive layer on its back-side that can be applied to a surface of a physical item. For example, if no adhesive is present of the back-side of the substrate layer, an adhesive may be applied to the physical item to which the substrate layer is to be applied. The substrate layer can be, for example, a vinyl film, such as polyvinyl chloride or polyvinyl alcohol.

Thus, the camouflage systems 130, 140, and 150 can be a conformable and adhere-able polymer based strata-structure that allows the same camouflage imagery to be continued or incorporated into both frictional-need areas and non-frictional-need portions of the cover material. The underlying adhesive, substrate, and digital printed layers can comprise the same such layers shown and described in detail in U.S. patent application Ser. No. 12/221,540 for CAMOUFLAGE PATTERNS, ARRANGEMENTS AND METHODS FOR MAKING THE SAME and U.S. patent application Ser. No. 12/386,986 for VISUAL CAMOUFLAGE WITH THERMAL AND RADAR SUPPRESSION AND METHODS FOR MAKING THE SAME; the entireties of both these applications are incorporated herein by reference. For instance, the system can utilize digitally produced, camouflage pattern imagery, which having been derived through Geospatial Intelligence (hereinafter “GEOINT”), or site-specific digital photography (like PHOTO REAL or PHOTO STEALTH camouflage manufactured by MW Defense Systems, Inc. located in Lumberton, N.C.), can be adhered and can feature a frictionalized outer micro-terrain, and feature a coordinating tractional grip frame system.

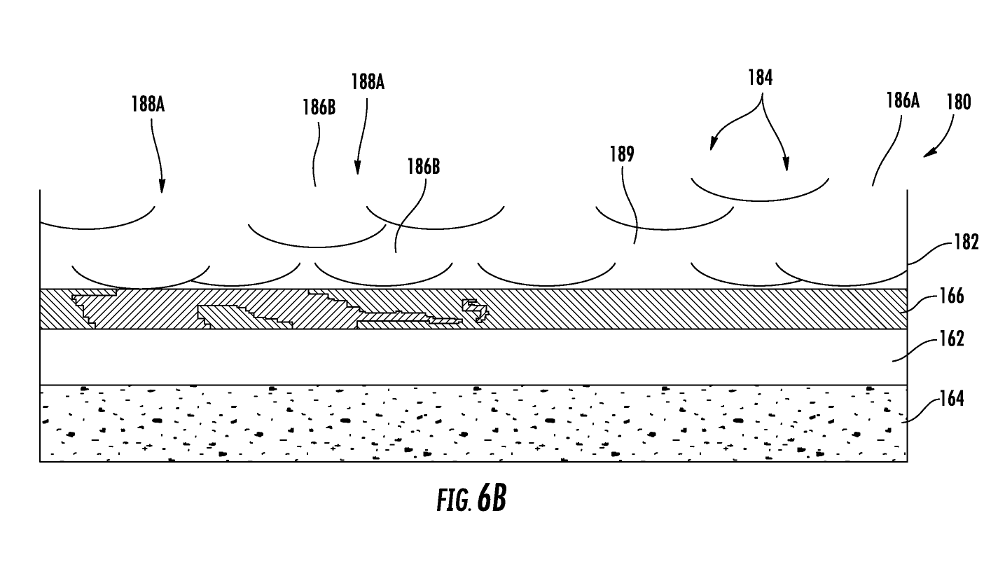

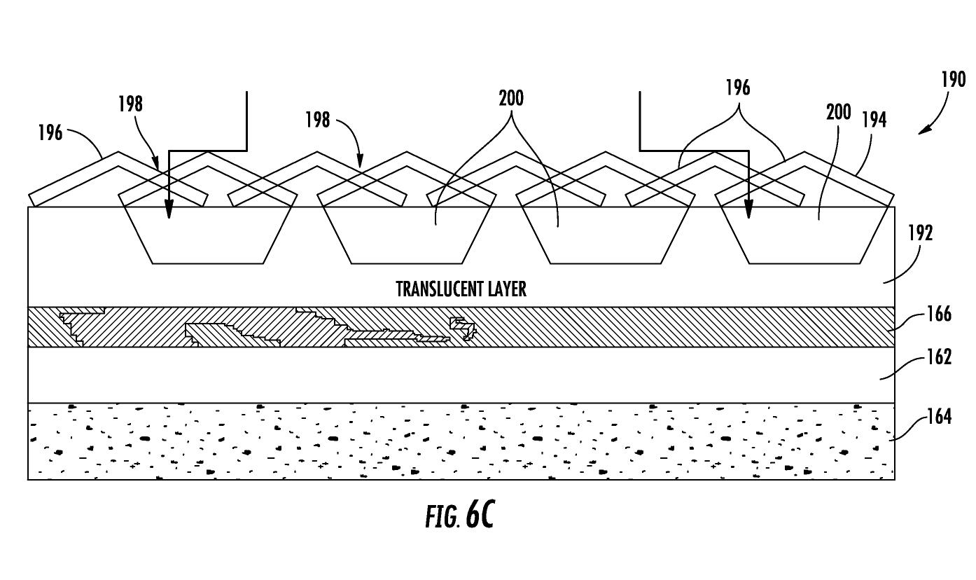

As stated above, micro-terrain layers can be applied over certain areas of a base camouflage system such a vinyl laminate wrap material similar to the substrate, print, laminate and adhesive layers described above used to cover a physical item. In some embodiments, different micro-terrain layers can be applied at different locations of such a cover material. For example, different micro-terrain layers having different microstructures can be applied at different locations on the cover material to provide different grip capabilities at those locations. Examples of some different microstructures are shown in FIGS. 6A-6C. In the embodiments shown in FIGS. 6A-6C, the micro-terrain layers have been applied on the print layers and substrate layers as protective layers over the print layers. However, it is understood that a laminate layer can intervene between the print layer and the micro-terrain layer in each embodiment. Further, such a print layer, substrate layer and laminate layer can constitute a camouflage system with the micro-terrain layer being a separate layer that is strategically applied to laminate layer after application of the print layer, substrate layer and laminate layer to a physical item.

In FIG. 6A, a magnified view of a portion of a camouflage system 160 is provided that comprises a substrate layer 162, an adhesive layer 164 and a print layer 166. The camouflage system 160 also comprises a micro-terrain layer 168 with microstructures 170 on its outer surface covers and protects the substrate layer 162 and print layer 166. The microstructures 170 include pointed ridges 172 that form peaks. The material from which the micro-terrain layer 168 is constructed can be soft and pliable. The microstructures 170 also include valleys 174 or open spaces between the pointed ridges 172 or peaks. The valleys 174 can extend down to a base portion 176 of the micro-terrain layer 168.

In FIG. 6B, a different structure is provided from the microstructures. A camouflage system 180 is provided that comprises a substrate layer 162, an adhesive layer 164 and a print layer 166. The camouflage system 180 also comprises a micro-terrain layer 182 with microstructures 184. The microstructures 184 include cylindrical ridges 186A and 186B of different sizes and heights. For example, the microstructures 184 include large cylindrical ridges 186A and small cylindrical, ridges 186B. Different sized valleys 188A and 188B, or open spaces, are formed between the large cylindrical ridges 186A and small cylindrical ridges 186B and between cylindrical ridges 186A and 186B and a base portion 189 of the micro-terrain layer 182. By increasing the differences in elevations in the physical structure of the micro-terrain layer 182, further improvements for handheld traction can be achieved. The differences in the elevations create cavities between the “ridges and valleys” of the micro-terrain, for the accumulation of sweat and oils.

In FIG. 6C, a camouflage system 190 is provided that comprises a substrate layer 162, an adhesive layer 164 and a print layer 166. The camouflage system 190 also comprises a micro-terrain layer 192 with microstructures 194 of ridges 196 and valleys 198. The micro-terrain layer 192 can include pockets 200 with the microstructures 194. The pockets 200 beneath the microstructures 194 of the transparent or semi-transparent micro-terrain layer 192 can be filled with or can house and protect transparent or semi-transparent multi-spectral signature suppression materials therein.

Also, micro-terrain layers can be overlaid on other micro-terrain layers. For example, a micro-terrain layer can be placed on top of hydrophobic coatings in areas on the device associated with heavy handheld use.

The camouflage system with a micro-terrain layer either selectively positioned on the material or entirely forming the outer most layer of the material can be applied to physical items to create a gripping or frictional contact surface that does not interfere with operation of the physical item. Such a camouflage system does not have to interfere with the functioning of the underlying surface to which it is applied, or from which it is subsequently removed.

Such camouflage systems, as described above, can be supplied at least in portions in kits. The installation of the different embodiments of camouflage systems on the physical items can depend on the type of camouflage systems and the physical item being covered. For example purposes only, an installation process for securing the camouflage system to a weapon or other accessories is described in more detail below. Weapons and accessories camouflage systems can be designed to be installed on a wide variety of personnel equipment and weapons systems to reduce detectable signatures in an operational environment. These weapons and accessories camouflage systems can be provided in kits. Each kit can incorporate camouflage vinyl film material as described above that can be applied in layers and can be removed as needed; grip material of a micro-terrain layer that be strategically placed on the physical item, such as a weapon, at points where handling of the physical item occurs to increase grip or traction; and tools and components that can be used in applying the site specific camouflage vinyl film material and the grip material.

The camouflage vinyl film material can be site specific camouflage vinyl film material as described above. The site specific camouflage vinyl film material can be tailored to the operational areas in which the weapon or accessory to be covered is used through photo realistic camouflage developed and sold by Military Wraps of Lumberton, N.C., under the name PHOTO STEALTH™. The site specific camouflage vinyl film material can incorporate multi-ply or multi-layering technology as disclosed in U.S. patent application Ser. No. 12/319,920 incorporated by reference herein in its entirety. The multi-ply or multi-layering technology allows single use layer or multiple layers that can be removed from the weapon or accessory as a mission progresses through separate environments.

The grip material, or micro-terrain layer can be opaque, clear, translucent or semi-translucent. The micro-terrain layer can be vinyl film material that can be applied over a vinyl film layer that has been applied to a weapon or accessory. The grip material can have an adhesive layer on one side that permits its application to the weapon or accessory on which it is used. The grip material can have a friction creating texture on the other side that can increase the traction between the hand of the user and the weapon or accessory. The texture on the grip material and the grip material is transparent enough to limit its interference with the visual effect of the camouflage layer on which it is applied. The grip material can be the vinyl grip material developed and sold by Military Wraps of Lumberton, N.C., under the name CAMO TRACTION™. The grip material can be applied to the weapon or accessory where traction, handling, and control are needed most.

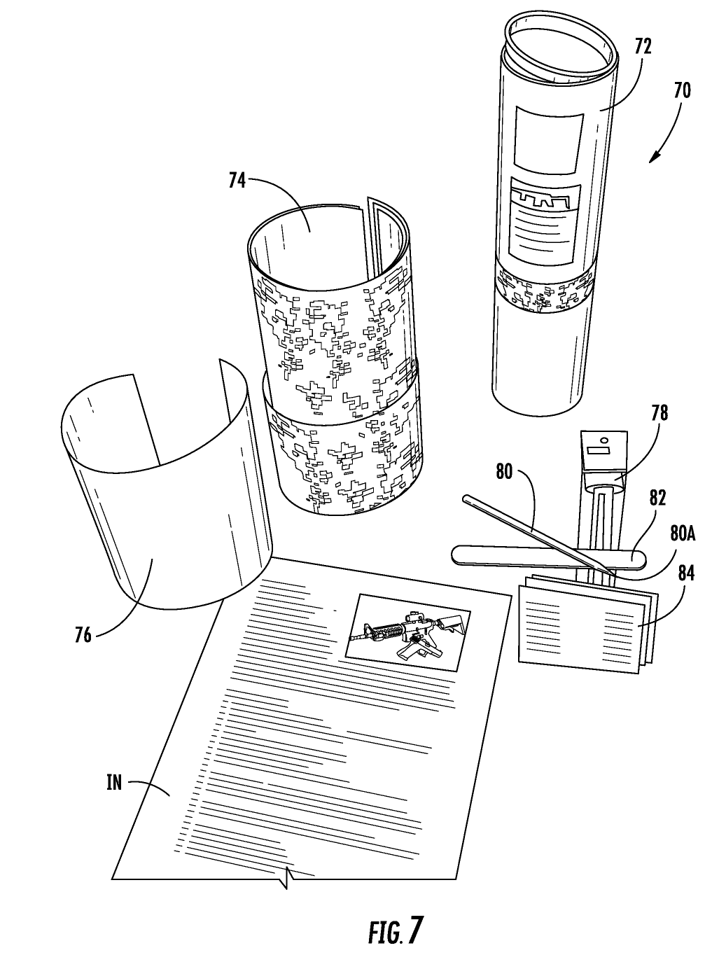

For example FIGS. 7 and 8 illustrate a kit, generally designated 70, that includes material and components used to effectively camouflage weapons and other accessories. Each kit 70 can include material and components that are specific to a specific weapon-type or specific accessory. Alternatively, the kit 70 can be a generic kit that includes components that can cut and fit the materials to generally any hand weapon or accessory.

The kit 70 can include a container 72 can be used to ship and store the kit materials and components. The kit can include camouflage vinyl film wrap, or camouflage layer, panels 74. These panels 74 can be specifically shaped to a specific weapon or accessory or can be general sizes that permit the panels to be cut to fit a specific weapon or accessory during application. The panels 74 can be camouflage vinyl wrap material that can provide visual, thermal and/or radar detection suppression. The panels can also be site specific camouflage vinyl wrap material as shown and described in U.S. patent application Ser. No. 12/386,986.

The kit 70 can also include one or more grip material, or micro-terrain layer, panels 76. The micro-terrain layer panels 76 can comprise the grip material described above. For example, the grip material can be the vinyl grip material developed and sold by Military Wraps of Lumberton, N.C., under the name CAMOTRACTION™. These micro-terrain layer panels 76 can be specifically shaped to a specific weapon or accessory or can be general sizes that permit the panels 76 to be cut to fit a specific weapon or accessory during application. The micro-terrain layer panels 76 can be camouflage vinyl wrap material that provides visual, thermal and radar detection suppression. The micro-terrain layer panels 76 can be clear or translucent enough to limit its interference with the camouflage layer panels 74 over which it is applied. As shown, the micro-terrain layer panels 76 have a backing that can be removed for application. The grip panels 76 can be cut to size or if pre-made to a specific shape. The micro-terrain layer panels 76 can then be place in positions on the weapons or accessories where traction, handling, and control are needed most.

The kit 70 can also include different components used in installing the panels 74 and 76. For example, the kit 70 can include a knife 78 for cutting the respective panels 74 and 76 as needed to fit the weapon. For instance, the knife 78 can be a clip blade knife. The kit 70 can include a detail stick 80 that can be used to apply the respective panels 74 and 76 to a weapon or accessory. The detail stick 80 can have a point 80A that can be used to ensure even and tight application in crevices in corners in the weapon or accessory. The kit 70 can also include a flat detail stick 82 that can be used to apply the respective panels 74 and 76 to a weapon or accessory. The flat detail stick 82 can be used to apply the respective panels 74 and 76 on larger, generally more flat surfaces of a weapon or accessory to remove bubbles under the panels and ensure an even tight application of the respective panels 74 and 76. The kit 70 can also include cleaning components, such as alcohol prep wipes 84. The alcohol prep wipes 84 can be used to clean the weapon or accessory before application of the respective panels 74 and 76 thereto. The cleaning components can be something other than alcohol prep wipes, for example, a container of a cleaning agent and a cloth or cotton swaps. The kit 70 can also include instructions IN on how to use the kit to camouflage a weapon or accessory. The instructions can be weapon or accessory specific or can be more generic.

The following are example methods of installation of the camouflage and micro-terrain layers for the example of the kit provided above. Other methods may be used. Moving parts should generally not be covered. Generally, weapons and weapon systems are designed with a close set of operating tolerances and foreign materials should generally not come into contact with operating levers, stops, covers, wells, clips, screws, pins, slides, rails, or the like. Since the kits 70 can contain sharp knife 78 to aide in installation, caution should be used when cutting materials and the user should ensure that proper cutting surfaces and methods are used.

In some embodiments, the vinyl material used in the panels 74 and 76 can have an operating temperature range of up to about 267° Fahrenheit. Thus, in such embodiments, the panels 74 and 76 generally should not be applied to the barrel of a high cyclic rate weapon system. If a user is unsure of the normal operating temperature range of the weapon or accessory being covered, the technical manual for the weapon or accessory should be consulted.

The vinyl material used in the panels 74 and 76 can be very flexible and will conform to round, flat, and textured surfaces. The material is self adhesive and can use an adhesive that can set up in 24 hours once being removed from its backing. A heat source can be used to help with adhesion, flexibility, forming and removal as necessary. Approved heat sources for use with this material can be, for example an electrical hair dryer, and electric heat gun, and a gas burst torch, such as a propane torch. When using a heat source, the user should generally not concentrate heat in one are when warming film. The user can use a back and forth motion to warm the piece of material being used evenly. The warmed material of the panels 74 and 76 can be extremely flexible and can be formed into edges, textures and corners to make finish more seamless. The material of the panels 74 and 76 generally should not be a heat shrink material and can stretch and conform when heated.

To begin application, the weapon or accessory can be disassembled and cleaned. Metal moving parts on the inside of the weapon can be oiled, while the other not moving part that are to be covered do not need to be oiled. An alcohol wipe preparation 84 can be removed from its package and used to wipe down surfaces to be covered by the panels 74 and 76. There can be several wipes 84 in a kit 70 that can be used for the stock, receiver area and, front hand guard/stock of a weapon. The user does not have to finish the entire weapon at one time. The user may stop and start as his or her schedule requires. It is recommended to use one wipe at a time to do the pieces with which the user will be working.

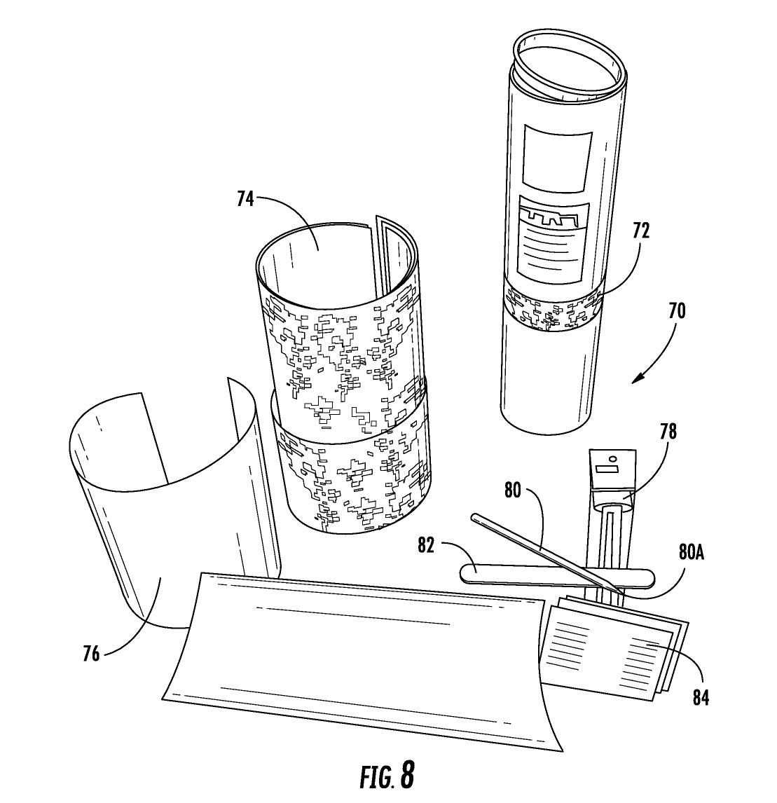

To apply the panels to a weapon, the user can begin with the rear stock portion of the weapon. For example as shown in FIG. 9, the rear stock 90 of a weapon can be match size of camouflage panel 74 to side of stock to be completed. The backing of the panel 74 can be removed and material can be worked onto the stock from one edge as shown in FIG. 10. The panel 74 can be rubbed back and forth across the width of the surface starting at the lead edge 92 as shown in FIG. 10. The panel 74 can then be worked across the length while ensuring that no air pockets under the panel 74 are created. The edges of the camouflage panel 74 can be pulled tight around the exposed ends to cover the end 90A. If necessary, a cover piece can be cut from a panel 74 to cover the entire end. The next application of a panel 74 can be used to cover the edges of the last installed panel 74. For example, a user can allow for a minimum of ⅛^{th} of an inch over lap on seams. Using a small heat source to warm the material can aid in flattening the seam areas. Excess material can be trimmed so that no loose ends are overlapping operating areas or other sections.

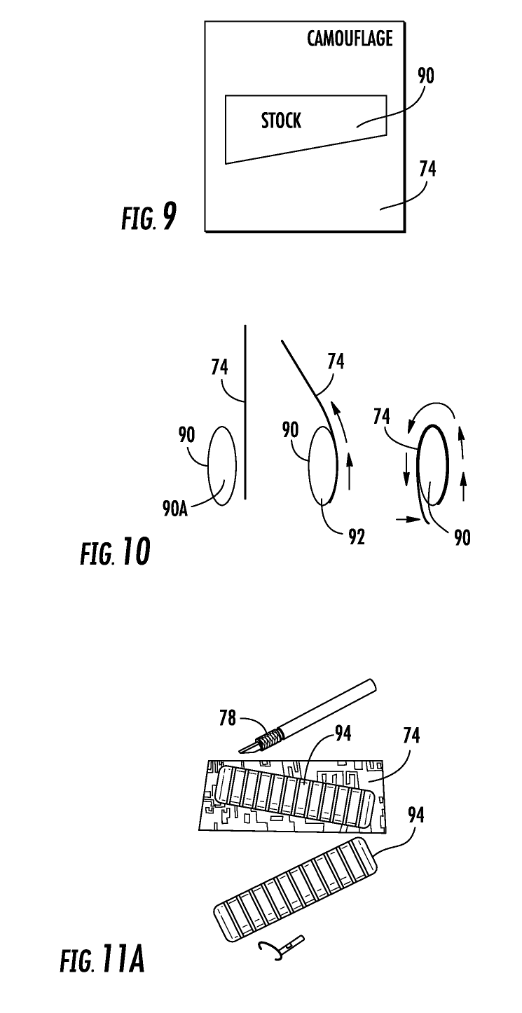

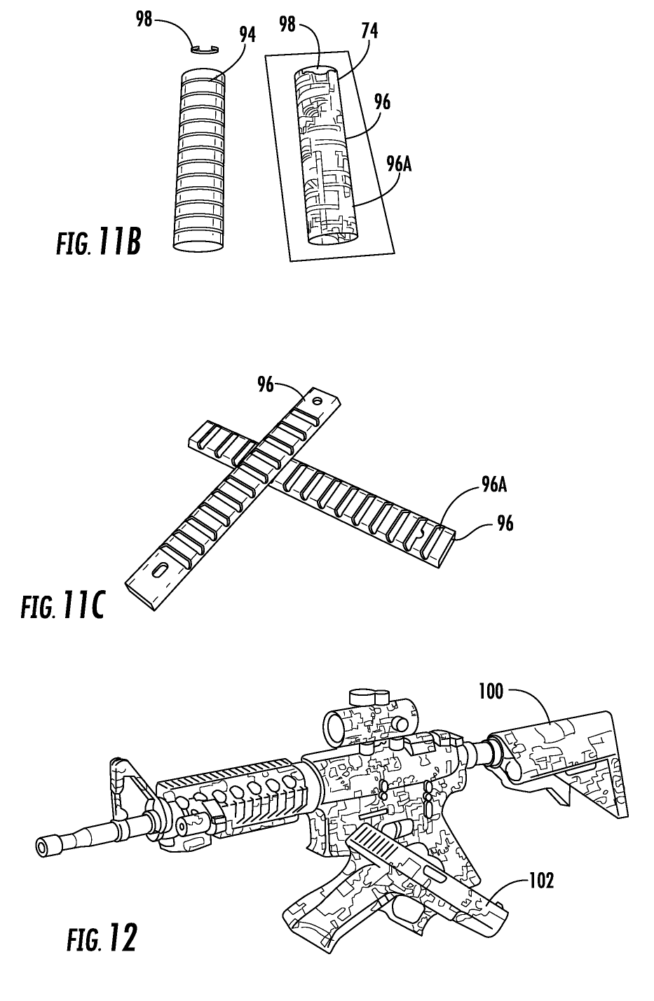

The different tools and components that come with the kit 70 can be used to work the panels 74 and 76 into small detail areas of the weapon. As shown in FIGS. 11A-11C, a panel 74 can be cut to size to fit a handle grip 94 of a weapon with a knife 78. As shown in FIG. 11B, the panel 74 can be applied to a handle grip 94 to create a camouflaged handle grip 96. The panel 74 as shown with the camouflaged handle grip 96 can be worked into crevices 96A with a detail stick 80 (see FIGS. 7 and 8) and over flat surfaces with flat detail stick 82 (see FIGS. 7 and 8). The working of the camouflaged panel 74 around crevices and holes 96A of camouflaged handle grips 96 are also shown in FIG. 110. Moving parts or other parts not to be covered by the camouflaged panel 74, such as part 98, can be reinserted in the camouflaged handle grip 96 after application of the camouflaged panel 74 as shown in FIG. 11B. The flat detail stick 82 in the kit 70 can be used for large flat areas and a pointed end 80A of the detail stick 80 can be used for small flat areas and crevice areas. This process can be continued for the entire weapon or equipment on which it is being applied. As stated above, the grip panels 76 are clear and can be installed where the user needs to ensure traction and grip. The grip panels 76 can be simply cut to the shapes needed on hand guards and pistol grips and other like areas and then applied in a manner similar to those described above with respect to the panels 74.

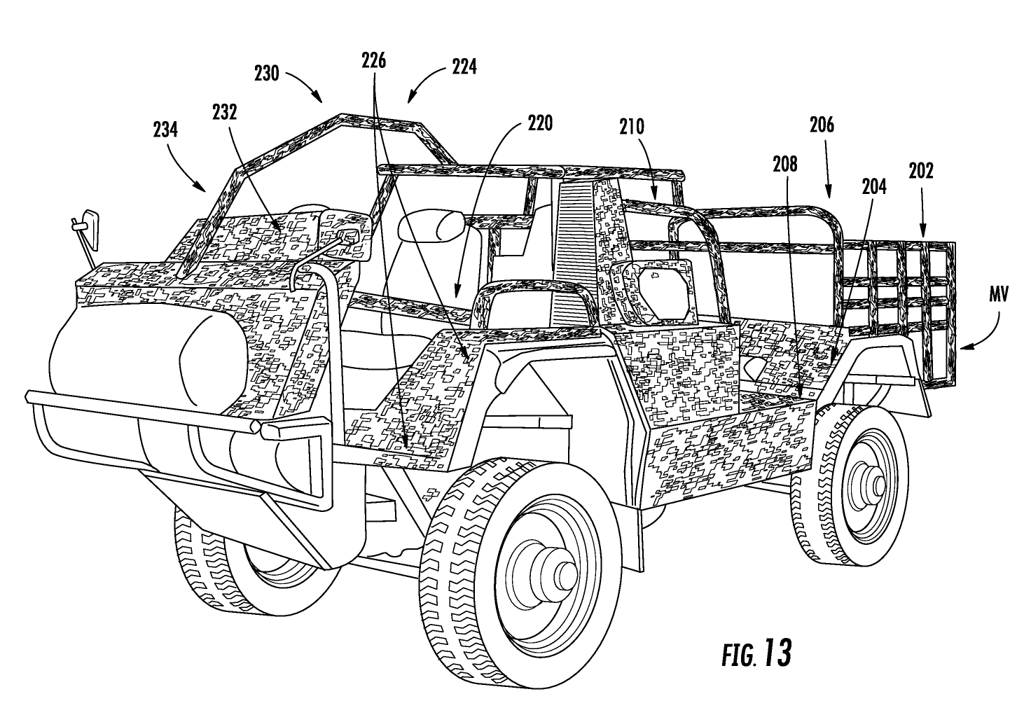

The camouflage panels 74 and the grip panels 76 are designed to be extremely durable. The surface can be sealed to prevent staining. Once the panels are properly installed, as shown in FIG. 12, the weapons 100 and 102 can be camouflaged. To clean to weapon or accessory after installation, a simple wipe down is all that is necessary for maintaining the appearance of the camouflaged weapon or accessory. If the camouflage surface requires more than average cleaning, it can be cleaned with any average mild detergent. The camouflaged weapon can be washed and dried off, and then the operating surfaces can be oiled as needed. The camouflage panel 74 and grip panels can be made from materials that are tested and rated to a decontamination standard level of 9.

Other material specifications for the material used to make the panels 74 and 76 can include the following:
Available in customizable patterns/Kits;
Fully operated by end user/self sustainable;
Non-toxic, Easy installation, and Easy reconfiguration, no special tools or processes required;
Non-Damaging, Simple removal;
Adds no slip grip where each operator needs it most;
Operating temperature range of −60 F to 267 F;
Will not interfere with gauging or function;
Deet Proof (tested in 40% solution saturation and soak);
RTCA/D0160 Category B (25 cycles) which combines altitude with humidity and freezing temperatures;
Environmental contaminants resistant. Common contaminants of interest include cleaning agents, lubricants, insecticides, and fuels. Military and aerospace applications as detailed in MIL-STD-810 and RTCA/DO 160. MIL-STD-810F; Method 504, MIL-STD-810F; Method 510.4, MIL-STD-810F; Method 510.4, MIL-STD-810F; Method 510.4MIL-STD-810, MIL-STD-810F; Method 512.4, MIL-STD-810F; Method 506.4, Telecordia/Verizon Wind Driven Rain specification. This includes rain of various amounts and wind exceeding 100 MPH Driving Rain, Contamination by Fluids, Blowing sand, dust and settling dust, Immersion, Rain;
Xenon, UVA, UVB. Xenon arc testing;
Steam Cleaning (water @ 93 C, 1400 kPa);
Pressure Washing (with detergent @ 40 C, 7000 kPa); and
DECON properties TRL9.

As stated above, while the kit example described above includes both camouflage panels and micro-terrain layer panels, depending on the physical item and the type of camouflage system being installed, the kit can contain different items. For example, for a camouflage system that has a micro-terrain layer applied directly to the print layer and substrate layer or the laminate layer before application to the physical item, an extra micro-terrain layer may not be needed. Also, different types of camouflage layers, for example some with thermal and/or radar suppression characteristics and some without such characteristic and/or different types of micro-terrain layers can be included in the same kit. Similarly, for kits that are used to place gripping surfaces on already camouflaged physical items such as military vehicles, then the kit may include only transparent, translucent, or semi-translucent micro-terrain layer panels which may have the same or different microstructures.

For example, as shown in FIG. 13, a vehicle MV that has been camouflaged can be provided that could use frictional surfaces at strategic locations. A kit with different panels of micro-terrain layers can be provided to create different frictional surfaces for foot traction and hand traction, for example. One set of micro-terrain layers can be applied as described above to locations 202, 206, 210, 220, 224, 230, 232, 234 where personnel tend to grasp and hold on the vehicle with their hands. Another set of micro-terrain layers can be applied as described above to locations 204, 208, 226 where personnel tend to need a frictional surface on the vehicle for their feet. Alternatively, the same type of micro-terrain layer can be used to create a frictional surface for both hands and feet.

Embodiments of the present disclosure shown in the drawings and described above are exemplary of numerous embodiments that can be made within the scope of the present subject matter. It is contemplated that the configurations of kits, systems and methods for camouflaging weapons and accessories can comprise numerous configurations other than those specifically disclosed.

What is claimed is:

1. A camouflage system for securement to a physical item, the system comprising:
a substrate layer having a front surface and a camouflage pattern on the front surface; and
one or more micro-terrain layers disposed over the camouflage pattern and the front surface of substrate layer forming at least a portion of an outer surface of the camouflage system to create a frictional contact surface.

2. The system according to claim 1, wherein the substrate layer is a vinyl layer.

3. The system according to claim 1, wherein the camouflage pattern comprises a site-specific camouflage pattern.

4. The system according to claim 3, wherein the camouflage pattern comprises a site-specific digital photographic image printed on the substrate layer.

5. The system according to claim 1, wherein the one or more micro-terrain layers further comprise microstructures that create ridges and valleys on the outer surface.

6. The system according to claim 1, wherein the one or more micro-terrain layers further comprise one or more nanomaterials disposed therein.

7. The system according to claim 1, wherein the one or more micro-terrain layers are transparent, semi-transparent, or translucent.

8. The system according to claim 1, further comprising a laminate layer secured over the front surface of the substrate layer between the micro-terrain layer and the camouflage pattern to provide protection to the camouflage pattern and strengthen the substrate layer.

9. The system according to claim 8, wherein one or more nanomaterials disposed on at least one of the substrate layer, the camouflage pattern, the one or more micro-terrain layers, or the laminate layer to provide at least one of thermal or radar suppression.

10. The system according to claim 8, wherein a nanomaterial of the one or more nanomaterials is mixed into a material used to create the laminate layer before the laminate layer is formed.

11. The system according to claim 1, further comprising one or more nanomaterials disposed on at least one of the substrate layer, the camouflage pattern, or the one or more micro-terrain layers to provide at least one of thermal or radar suppression.

12. The system according to claim 11, wherein the nanomaterial is mixed into a substrate material used to create the substrate layer.

13. The system according to claim 11, wherein the one or more nanomaterials comprise at least one of microspheres or an aerogel in powder form.

14. The system according to claim 11, wherein the camouflage pattern comprises ink and a nanomaterial of the one or more nanomaterials are mixed into the ink before printing of the camouflage pattern onto the substrate layer.

15. The system according to claim 1, further comprising an adhesive layer disposed on a surface of the substrate layer opposite the front surface on which the camouflage pattern is disposed.

16. The system according to claim 15, wherein the adhesive layer further comprises one or more nanomaterials disposed therein.

17. The system according to claim 1, wherein the physical item to which the camouflage system is securable comprises a weapon.

18. The system according to claim 1, wherein the physical item to which the camouflage system is securable comprises a vehicle.

19. A visual camouflage system providing at least one of thermal or radar suppression, the system comprising:
a vinyl layer having a camouflage pattern on a front surface of the vinyl layer, the camouflage pattern comprising a site-specific camouflage pattern;
one or more micro-terrain layers disposed over the camouflage pattern on the front surface of vinyl layer forming at least a portion of an outer surface to comprises a frictional contact surface;
a laminate layer secured over the front surface of the substrate layer between the micro-terrain layer and the camouflage pattern to provide protection to the camouflage pattern and strengthen the substrate layer;
a pulverized aerogel disposed on at least one of the vinyl layer, the camouflage pattern, the one or more micro-terrain layers, or the laminate layer to provide thermal suppression; and
microspheres disposed on at least one of the vinyl layer, camouflage pattern, the one or more micro-terrain layers, or the laminate layer to provide radar suppression.

20. A kit for applying at least a portion of a camouflage system to a physical item, the kit comprising:
a panel of material that comprises at least a portion of a micro-terrain layer;
one or more components used to align and attach the panel of material to the physical item so that the micro-terrain layer is positioned on the physical item to provide a frictional surface for gripping and/or traction for personnel that use the physical item; and
a container for holding the panel of material and one or more components.

21. The kit according to claim 20, further comprising a panel of a camouflage layer that comprises a substrate layer having a camouflage pattern on a front surface of the substrate layer, the camouflage pattern comprising a site-specific camouflage pattern.

22. The kit according to claim 21, wherein the panel of material is a panel of a micro-terrain layer that can be secured to the panel of the camouflage layer.

23. The kit according to claim 20, wherein the one or more components comprises a knife for cutting the panel of material to a proper size.

24. The kit according to claim 20, wherein the one or more components comprises detail sticks for smoothing the panel of material on the physical item.

25. The kit according to claim 20, wherein one or more components comprises an alcohol wipe for cleaning the physical item before securement of the panel of material.

26. The kit according to claim 20, wherein the physical item to which the camouflage system is securable comprises a weapon.

27. The kit according to claim 20, wherein the physical item to which the camouflage system is securable comprises a vehicle.

28. A method of making a site-specific visual camouflage system, the method comprising:
providing a substrate layer;
printing a camouflage pattern on a front surface of the substrate layer, the camouflage pattern comprising a site-specific camouflage pattern;
securing a laminate layer over the front surface of the substrate layer, the laminate coating the camouflage pattern to provide protection to the camouflage pattern and strengthen the substrate layer; and
securing one or more micro-terrain layers over the laminate layer to create at least a portion of an outer surface of the camouflage system to form a frictional contact surface to provide traction.

29. The method according to claim 28, further comprising adding one or more nanomaterials on at least one of the substrate layer, the camouflage pattern, the one or more micro-terrain layers, or the laminate to provide at least one of thermal or radar suppression.

30. The method according to claim 29, wherein the one or more nanomaterials comprise at least one of an aerogel in powder form or microspheres.

31. The method according to claim 29, further comprising applying an adhesive layer to a surface of the substrate layer opposite the front surface of the substrate layer.

32. The method according to claim 31, wherein the step of adding the one or more nanomaterials includes mixing the nanomaterial into the adhesive before application of the adhesive layer onto the substrate layer.
